(19) United States
(12) Patent Application Publication
(10) Pub. No.: US 2008/0062407 A1
(43) Pub. Date: Mar. 13, 2008

(54) Method and apparatus for increasing the security of the physical fiber plant by polarization monitoring

(76) Inventors: Mikhail Boroditsky, South Amboy, NJ (US); Mikhail Brodsky, Millburn, NJ (US); Nicholas J. Frigo, Annapolis, MD (US); Peter Magill, Freehold, NJ (US)

Correspondence Address: AT&T CORP., ROOM 2A207, ONE AT&T WAY, BEDMINSTER, NJ, 07921, US

(21) Appl. No.: 11/513,461

(22) Filed: Aug. 31, 2006

(51) Int. Cl. G01N 21/00; H04B 10/08

(52) U.S. Cl. 356/73.1; 356/364; 398/29

(57) ABSTRACT

A method and system for detecting intrusions on a fiber optic network. The method and system monitors polarization variations of light being transmitted in the fiber optic network. It then determines intrusions in the fiber optic network based on the polarization variations. The polarization variations are then compared to a database of known activity which would cause polarization variations to determine unknown intrusions. An intrusion alert is initiated when the determined intrusion does not correspond to any known activity. The known activity is contained in an automated database for automatically comparing to the polarization variations. The intrusions may be cross-correlated on two partially adjacent fiber optic cables to determine the location of the intrusion.

### BACKGROUND OF THE INVENTION

The present invention relates generally to fiber optic network networks, and more particularly to polarization monitoring to detect intrusions on fiber optic networks.

Optical communications is a fast advancing technology. As the transmission of information using fiber optic cables increases, security risks become of growing concern, especially if military or other highly sensitive information is being transmitted. One prior art method of security for optical communications includes manual surveillance. Another prior art method includes installing fiber optic cables in pressurized pipes, and then generating an alert whenever pressure monitors detect a variation in the pressure beyond some threshold (e.g., whenever a pipe is disturbed). These methods can be inaccurate and generally require added human resources and/or equipment in addition to that needed for installation and operation of the optical network.

In optical communications, information is conventionally encoded for transmission using the amplitude and frequency of a lightwave. Traditionally and most simply, the lightwave source is a laser and therefore the optical signal is well-polarized. That is to say, it has a clearly defined state of polarization. While during transmission through an optical fiber this state of polarization is altered, the light remains nearly in a single, well-defined state. It is not smeared out into a state of unpolarized light.

### SUMMARY OF THE INVENTION

The present inventors have invented a method and system detecting for detecting intrusions on a fiber optic network. The method and system monitors polarization variations of light being transmitted in the fiber optic network. It then determines intrusions in the fiber optic network based on the polarization variations. The polarization variations are then compared to a database of known activity which would cause polarization variations to determine unknown intrusions. An intrusion alert is initiated when the determined intrusion does not correspond to any known activity. The known activity is contained in a database for automatically comparing to the polarization variations. The intrusions may be cross-correlated on two partially adjacent fiber optic cables to determine the location of the intrusion. These and other advantages of the invention will be apparent to those of ordinary skill in the art by reference to the following detailed description and the accompanying drawings.

### BRIEF DESCRIPTION OF THE DRAWING

FIG. 1 shows a block diagram of a fiber optic communication system constructed in accordance with an embodiment of the present invention;

FIG. 2 shows experimental polarization variation events;

FIG. 3 is a plot of the polarization variation events of FIG. 2;

FIG. 4 shows a high level block diagram of a computer capable of implementing the present invention;

FIG. 5 shows an exemplary record of the known polarization database;

FIG. 6 is a flow chart showing the steps of the method in accordance with an embodiment of the present invention; and

FIG. 7 is a diagram illustrating the cross-correlating method in accordance with an embodiment of the present invention.

### DETAILED DESCRIPTION

The present invention provides an efficient and effective method of providing enhanced security for fiber optic communication links and networks by exploiting the inherent physical properties of fiber optic cables to detect physical “disturbances” in an optical network. More particularly, the present invention relates to using state of polarization information and the birefringence properties of fiber optics to detect and monitor for physical intrusions of fiber optic based networks. If the fiber is perturbed at some point, e.g., by being moved or with a kink or a twist, the polarization of the propagating light is altered. This invention permits one to detect unplanned movements of the fiber plant, making tapping into the fiber network detectable. Under some circumstances, a small fraction of the input light in one polarization mode of the fiber is converted (or coupled) to a second polarization mode which is orthogonal to the original polarization mode. Due to the fiber birefringence, the index of refraction for each mode is different; thus, the original and orthogonal polarizations travel different effective optical distances from the perturbation to reach the remote location. This invention permits one to detect and partially locate unplanned movements of the fiber plant, making tapping into the fiber network detectable.

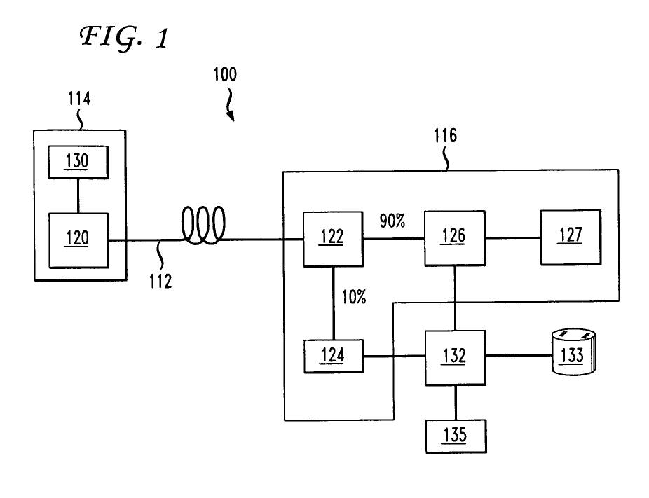

Referring now to the drawings and in particular to FIG. 1, a fiber optic communication system 100 constructed in accordance with the present embodiment is shown. The fiber optic communication system 100 uses the polarization of the light signal to enhance the physical security of one or more fiber optic links in optical network(s). A deviation from an expected pattern of polarization at the receiver system is due either to some physical “disturbance” of the fiber, or the relatively slow (“undisturbed”) time-varying nature of the birefringent properties of the fiber optic link.

The fiber optic communication system 100 has a transmitter system 114, and a receiver system 116. The transmitter system 114 includes a laser source 120 producing a light beam into the fiber optic link 112 to be transmitted along the fiber optic link 112. The receiver system 116 is provided with a coupler (or monitor port) 122 for splitting the light beam such that a portion (e.g. approximately 10%) of the light beam is directed to a polarimeter 124, and a portion (e.g. approximately 90%) of the light beam is directed to a light detector 126 for extracting data from the light beam. The light detector 126 receives the light signals transmitted by the laser source 120 and processes them as is well known in the art. A processor 127 processes the signals output by the light detector 126 as is well known in the art. The polarimeter 124 determines the state-of-polarization (SOP). and forwards data indicative of the polarization to a microprocessor 132. The microprocessor 132 analyzes the polarization of the light and determines whether there are any variations in the polarization. The polarimeter 124 determines if there are any changes in the SOP. For example a change in the SOP of 5 degrees or more in 10 ms. If there are any of these variations in the polarization, the microprocessor compares the variations to any expected variations in database 133. If there are any unexpected variations that are not in database 133, microprocessor 132 sends a signal to the intrusion notification system 135 to generate an alert indicating that an intrusion has taken place. The microprocessor 132, the database 133 and the intrusion notification system 135 may be inside or outside the receiver system 116

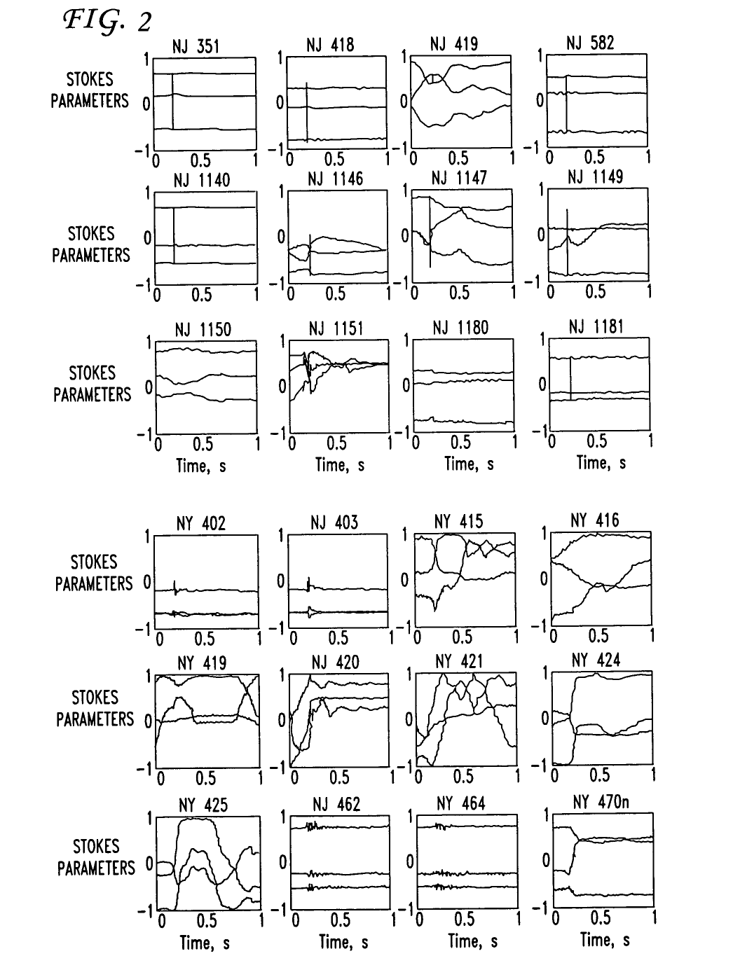

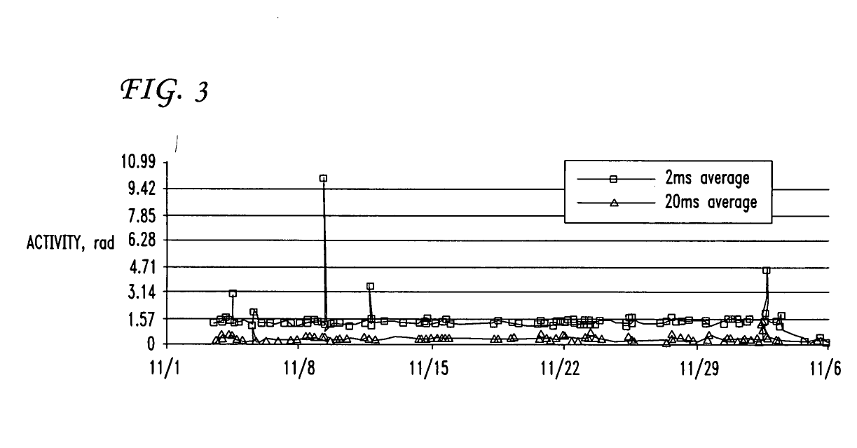

FIGS. 2 and 3 show different polarization variations measurements by a polarimeter in two different experimental settings. FIG. 2 shows a catalog of polarization events from an analysis of the SOP fluctuations in two operating lightwave systems, one urban, and one suburban. Several fast (<50 μs) polarization changes, and multiple slower polarization rotations were observed. All fast polarization effects were “elastic”, that is the SOP returned to its original state once the fast variations died out. The polarimeter was used to monitor a 40 km long route in suburban part of New Jersey from November 2004 to February 2005, and a 7 km long route between two buildings in New York, N.Y. A single WDM channel was selected by an optical bandpass filter in the monitor port of a 10 Gb/s fiber optic transmission system, and was passed to an Adaptif 1000 fast polarimeter. The polarimeter was set to self-triggering mode, so that data was stored only after an SOP motion of 5 degrees or more in 10 ms occurred. The sampling rate was 50 KHz; 200 ms of pre-trigger and 800 ms of post-trigger data were stored for each trigger event. A moving average filter was used to analyze the underlying medium-speed (10-30 ms) effects. Several of the observed events, however, could not have been detected without a fast polarimeter. Shown in FIG. 3 are essentially all significant polarization events, which were observed in the experiments, respectively. The horizontal axis is time, in seconds, the vertical axis plots the three dimensionless Stokes parameters. The labels correspond to the file numbers in a sequence.

Based on the data in FIG. 2, the polarization events shown in FIGS. 2 and 3 can be divided into three categories. 1) “Fast elastic,” when the SOP jumps or oscillates very fast (<1 ms), but comes back immediately. Such fluctuations of the SOP are unlikely to trigger any protection switching, or to confuse a slow-feedback polarimeter, since its control mechanism may not even notice event. 2) “Medium speed inelastic,” when SOP shifts away on a timescale of approximately 30 ms, and stabilizes there. 3) “Slow,” with a typical timescale of approximately 100 ms. These events, which were observed in both routes are most likely due to the craft personnel activity, and should be traceable to the planned intrusions.

Motion of the fiber optic cables changes the relative orientation of the SOP vectors. As shown in FIG. 3, the results are plotted as a function of time. It is easy to see that most of the data corresponds to the background noise, while only 4 events produce higher values, corresponding to the medium-speed SOP variations. The highest peak at 11/9 corresponds to a test event when the applicants shook a fiber jumper.

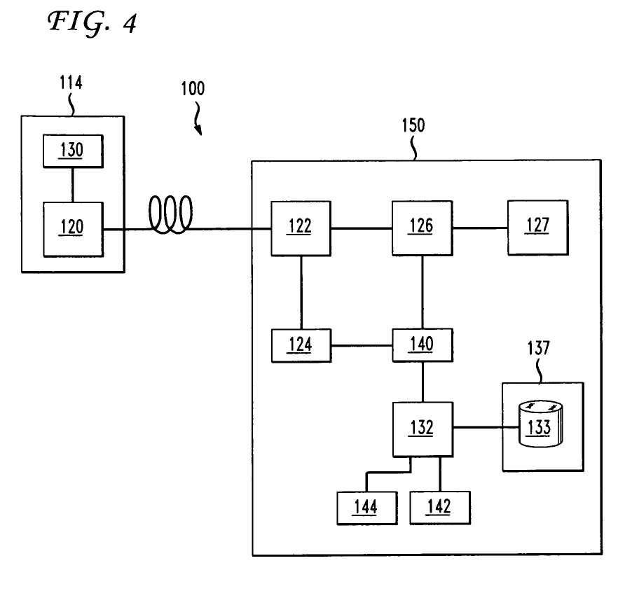

The method for increasing the security of the physical security of the physical fiber plant by polarization monitoring according to the present invention can be implemented as a computer program executed by computer system of a fiber optic transmission system. For example, the method may be implemented on a computer using well known computer processors, memory units, storage devices, computer software, and other components. A high level block diagram of such a computer is illustrated in FIG. 4. Computer 150 contains a processor 132 which control the overall operation of the computer 150 by executing computer program instructions, which define such operation. The computer program instructions may be stored in a storage device 133 (e.g., magnetic disk) and loaded into memory 142 when execution of the computer program instructions is desired. Thus, the polarization monitoring method can be defined by the computer program instructions stored in the memory 142 and/or storage 137 and the method will be controlled by the processor 130 and 132 executing the computer program instructions. Storage 137 is also used to store the database 133 of expected polarization variations. The computer 150 also includes one or more network interfaces 140 for communicating with other devices via a network. For example, the one or more network interfaces 140 can communicate with the polarimeter 124, the light detector 126 and the processor 127. The computer 150 also includes input/output 144 which represents devices which allow for user interaction with the computer 150 (e.g., display, keyboard, mouse, speakers, buttons, etc.). One skilled in the art will recognize that an implementation of an actual computer will contain other components as well, and that FIG. 4 is a high level representation of some of the components of such a computer for illustrative purposes.

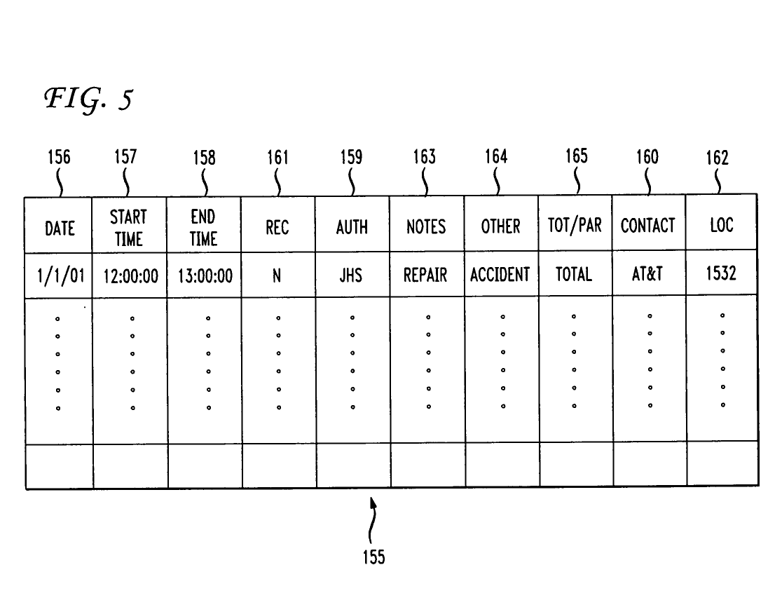

FIG. 5 shows a record of the database 133 of the present invention. The record 155 has fields for date 156, start time 157, end time 158, authorized by 159, contact information 160, recurrence 161, location 162, notes 163, other 164 and total/partial 165. As an example, the first record shows an expected polarization variation on the date 156 of Jan. 1, 2001 with a start time 157 of 12:00 hours and an end time 158 of 13:00 hours. There is no recurrence 161, and it was authorized 159 by a person with the initials JHS. Under the notes 163 section, it is noted that it is a repair, and under the other 164 section, it is noted that it is due to an accident. Under the Tot/Par 165 section, which stands for Total/Partial, it is noted that it is a total disruption in the fiber optic cable. Under the Contact 160 section, it is noted that the contact is AT&T. Finally, it is noted that the location 162 is designated by 1532, so that the location can be cross-correlated.

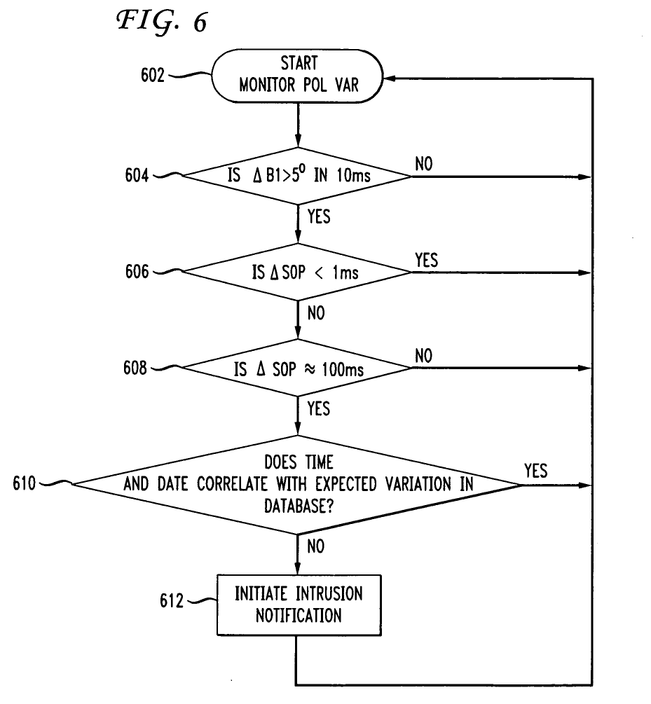

FIG. 6 shows a flow chart of a method in accordance with an embodiment of the present invention. The polarization variations are monitored and compared to expected variations in a database to determine if variations of the polarization indicate intrusions. At step 602, the fiber optic link 112 is monitored for variations in the polarization of the light. In step 604, it is determined if the amount of the variation of the SOP is greater than 5 degrees in 10 ms. If no, then the system continues monitoring the polarization, as the variation in the SOP is insignificant.

If the SOP variation is greater than 5 degrees in 10 ms, then that indicates a significant SOP variation. Then in step 606, it is determined if the duration of the SOP variation is less than 1 ms. If the duration of the SOP variation is less than 1 ms, then the variation of the SOP is insignificant, and the system continues monitoring the polarization. If the duration is greater than 1 ms, then the SOP variation is significant. Then in step 608, it is determined if the duration of the SOP variation is approximately 100 ms. If the variation is not approximately 100 ms, then the SOP variation does not indicate movement of the fiber optic cable, and the system continues monitoring the polarization.

If the SOP variation is approximately 100 ms, then movement of the fiber optic cable is probable. Then, in step 610, it is determined if the time, date and location of the SOP variation correspond with a known, expected SOP variation in the database 133 of expected fiber optic cable movements. If the time, date and location of the SOP variation correspond with a known, expected movement of the fiber optic cable listed in the database 133, then the intrusion is authorized and the system continues monitoring the polarization. If the time, date and location of the SOP variation do not correspond with a known, expected movement of the fiber optic cable listed in the database 133, then the intrusion is not authorized and an intrusion notification is initiated in step 612.

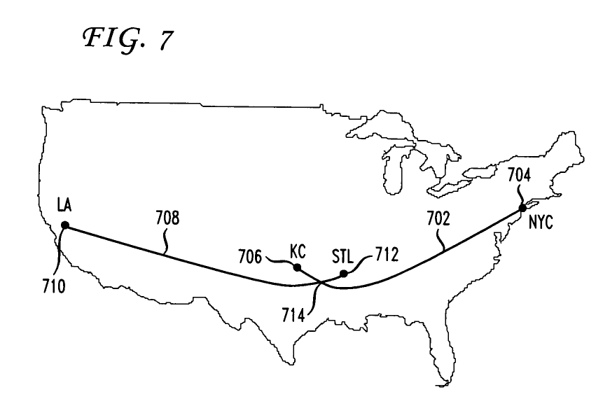

Even though it can be determined that an intrusion has taken place, it is useful to determine the approximate location of the intrusion. Fiber optic cables often are run along side of each other in conduits for part of their distance. By cross-correlating intrusions on several different fiber optic cables that run along side each other for at least some distance, it is possible to approximate the location of the intrusion. FIG. 7 shows a cross-country fiberoptic network. One fiberoptic link 702 runs from New York, N.Y. 704 to Kansas City, Mo. 706. A second fiber optic link 708 runs from Los Angeles, Calif. 710, to St. Louis, Mo. 712. In this network, for example, if polarization detectors on each of the fiber optic links 702 and 708 both detect polarization variations indicating intrusions at identical times, it can be cross-correlated that the intrusion took place between Kansas City 706 and St. Louis 712 where the fiberoptic links were adjacent to each other. Also, by cross-correlating the intrusions with other fiber optic cables, the location can be further pinpointed.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for detecting intrusions in a fiber optic network comprising the steps of:
monitoring polarization variations of light being transmitted in the fiber optic network;
determining intrusions in the fiber optic network based on the polarization variations; and
comparing a characteristic of the polarization variations to a database of known activity which would cause polarization variations.

2. The method of claim 1 wherein the characteristic of the polarization variation is the time of the polarization variation.

3. The method of claim 1 wherein the characteristic of the polarization variation is the date of the polarization variation.

4. The method of claim 1 wherein the characteristic of the polarization variation is the location of the polarization variation.

5. The method of claim 1 further comprising the step of generating an intrusion alert when the determined intrusion does not correspond to any known activity.

6. The method of claim 1 wherein the step of determining further comprises determining if the polarization variation is greater than five degrees within 10 milliseconds.

7. The method of claim 1 wherein the step of determining further comprises determining if the polarization variation is completed within 1 ms.

8. The method of claim 1 wherein the step of determining further comprises determining if the polarization variation is approximately 100 ms.

9. The method of claim 1 further comprising the step of cross-correlating the intrusions on two partially adjacent fiber optic cables to determine the location of the intrusion.

10. An intrusion detection system comprising:
means for monitoring polarization variations of light being transmitted in a fiber optic network;
means for determining intrusions in the fiber optic network based on said polarization variations; and
means for comparing a characteristic of the polarization variations to a database of known activity which would cause polarization variations.

11. The system of claim 10 wherein the characteristic of the polarization variation is the time of the polarization variation.

12. The system of claim 10 wherein the characteristic of the polarization variation is the date of the polarization variation.

13. The system of claim 10 wherein the characteristic of the polarization variation is the location of the polarization variation.

14. The system of claim 10 further comprising a means for generating an intrusion alert when the determined intrusion does not correspond to any known activity.

15. The system of claim 10 wherein the determining means determines if the polarization variation is greater than five degrees.

16. The method of claim 10 wherein the determining means determines if the polarization variation is greater than 1 ms.

17. The method of claim 10 wherein the wherein the determining means determines if the polarization variation is approximately 100 ms.

18. The method of claim 1 further comprising cross-correlating means for cross correlating the intrusions on two partially adjacent fiber optic cables to determine the location of the intrusion.

19. A fiber optic communication system, comprising:
a monitor;
a database;
a polarimeter for receiving the light signals transmitted by the transmitter and determining variations in polarization; and
a processor for comparing the variations in polarization to a database of known activity with would cause polarization variations to determine unknown intrusions.

20. The fiber optic communication system of claim 19, further comprising an intrusion notification system for generating a notification when the polarization variations do not correspond to the known activity in the database.

21. The system of claim 19 wherein the processor cross-correlates the intrusions on two partially adjacent fiber optic cables to determine the location of the intrusion.

22. A method for polarization-based intrusion monitoring in a fiber optic network, comprising the steps of:
transmitting a light signal having an expected state of polarization along the fiber optic network;
receiving the light signal and generating data indicative of the polarization of the light signal; and
comparing the data to a database of expected deviations of the state of polarization.

23. The method of claim 22 and further comprising the step of generating an intrusion alert when the deviation of the state of polarization does not correspond to any known activity.

24. The method of claim 22 wherein the known activity is contained in an database for automatically comparing to the polarization variations.

25. The method of claim 23 wherein the step of receiving further comprises determining if the polarization variation is greater than five degrees.

26. The method of claim 23 wherein the step of receiving further comprises determining if the polarization variation is greater than 1 ms.

27. The method of claim 23 wherein the step of receiving further comprises determining if the polarization variation is approximately 100 ms.

28. The method of claim 23 and further comprising the step of cross-correlating the intrusions on two partially adjacent fiber optic cables to determine the location of the intrusion.
